(19) United States
(12) Patent Application Publication
(10) Pub. No.: US 2020/0287929 A1
(43) Pub. Date: Sep. 10, 2020

(54) DETECTING AND REDUCING THE EFFECTS OF CYBERSECURITY THREATS ON A COMPUTER NETWORK

(71) Applicant: Duke University, Durham, NC (US)

(72) Inventors: Richard Alexander Biever, JR., Cary, NC (US); John Arnold Board, JR., Durham, NC (US); Jesse Rhea Bowling, Durham, NC (US); Tracy Ann Futhey, Durham, NC (US); Charles Laurence Kneifel, Cary, NC (US)

(21) Appl. No.: 16/644,697

(22) PCT Filed: Sep. 7, 2018
(86) PCT No.: PCT/US18/49856

§ 371 Date: Mar. 5, 2020

Related U.S. Application Data
(60) Provisional application No. 62/555,093, filed on Sep. 7, 2017.

(51) Int. Cl. H04L 29/06; G06F 21/62

(52) U.S. Cl. CPC H04L 63/1441; G06F 21/6245

(57) ABSTRACT

A threat analyzer that is configured to receive cybersecurity threat data, perform an analysis of the cybersecurity threat data, and determine an action to be performed by response software on response computers in response to a cybersecurity threat. The threat analyzer is also configured to add the cybersecurity threat data to a private threat repository on a private database.

### RELATED APPLICATIONS

The present application claims priority to U.S. Provisional Patent Application No. 62/555,093 the entire contents of all of which are incorporated herein by reference.

### FIELD

The present invention relates to detecting cybersecurity threats and reducing the effects of cybersecurity threats on a computer network.

### SUMMARY

Responding to cybersecurity threats presents several challenges. Present technology for defending against cybersecurity threats use threat detection information gathered and aggregated from the computer networks of organizations that subscribe to the technology to create packaged products for those same organizations. Latency is inherent in the process of developing packages for organizations, because the current practice is to analyze and validate each threat.

Embodiments described herein seek to reduce the latency in present solutions by, among other things, allowing for the sharing of cybersecurity threat data amongst a network of computer networks associated with a plurality of organizations. In some embodiments, threat detection information that is shared between organizations is cleaned so that it does not include information that may be used to identify the organization from which the data originated. As used herein, the term “organization” refers to any organization that has a computer network system that is vulnerable to an outside cyberattack. In some embodiments, the organization is a university or other research institution.

Each computer network associated with one of the plurality organizations includes a plurality of hardware and software that allows for detection of cybersecurity threats, analysis of detected cybersecurity threats, and responding to the detected cybersecurity threats. Detected threats are stored in a threat repository on a private database that is specific to an organization (a private threat repository) and in a threat repository on a shared database that is shared by a plurality of organizations (a shared threat repository). The threat analysis that is performed by each organization's network utilizes data stored in the shared threat repository of the shared database in addition to the data stored in the private threat repository associated with the organization.

In addition to assisting the organizations in the network respond to cybersecurity threats, the shared threat repository described provides research and development teams access to data that may aid them in the development of software for combating cybersecurity threats.

One embodiment, provides a threat analyzer that is configured to receive cybersecurity threat data, perform an analysis of the cybersecurity threat data, and determine an action to be performed by response software on response computers in response to a cybersecurity threat. The threat analyzer is also configured to add the cybersecurity threat data to a private threat repository on a private database.

Another embodiment provides a computer network for the detection and reduction of cybersecurity threats. The computer network includes a plurality of detection computers, each configured to, when executing detection software with an electronic processor, detect a cybersecurity threat. The computer network also includes a plurality of response computers, each configured to, when executing response software with an electronic processor, perform an action in response to the detected cybersecurity threat on the computer network. The computer network further includes a threat data aggregator configured to, when executed by the electronic processor, communicate with the plurality of detection computers and the plurality of response computers and to receive data regarding the detected cybersecurity threat and a threat analyzer configured to, when executed by the electronic processor, determine a response to the detected cybersecurity threat.

Other aspects and various embodiments will become apparent by consideration of the detailed description and accompanying drawings.

### BRIEF DESCRIPTION OF THE DRAWINGS

FIG. 1 illustrates a network of a plurality of computer networks, according to one embodiment.

FIG. 2 illustrates an example of one computer network included in the plurality of networks of FIG. 1, according to one embodiment.

FIG. 3 illustrates an example of a detection computer included in the computer network illustrated in FIG. 2, according to one embodiment.

FIG. 4 illustrates an example of a response computer included in the computer network of FIG. 2, according to one embodiment.

FIG. 5 illustrates an example of an analysis computer included in the computer network of FIG. 2, according to one embodiment.

FIG. 6 illustrates one example of the flow of data between hardware and software components in the network of FIG. 1 when a cybersecurity threat is detected in the computer network of FIG. 2 or a threat is added to the shared threat repository of FIG. 1.

FIG. 7 illustrates an example of a method for responding to cybersecurity threats in the network of FIG. 1, according to one embodiment.

FIG. 8 illustrates an example of functionality that the computer network of FIG. 2 is configured to perform when honeypot software detects a cybersecurity threat in the computer network of FIG. 2.

FIG. 9 illustrates an example of functionality that the computer network of FIG. 2 is configured to perform when system logs and authentication logs indicate a cybersecurity threat in the computer network of FIG. 2.

FIG. 10 illustrates an example of functionality that the computer network of FIG. 2 is configured to perform when an intrusion detection system software detects a cybersecurity threat in the computer network of FIG. 2.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, flash memory, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing.” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top, and bottom, and the like may be used herein solely to distinguish one entity or action from another entity or action without necessarily requiring or implying any actual such relationship or order between such entities or actions.

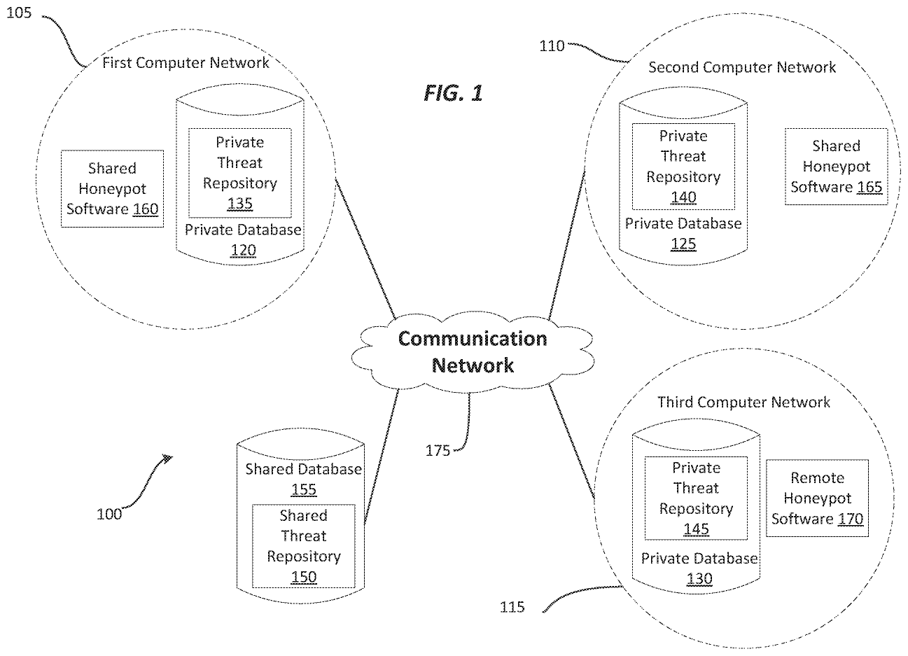

FIG. 1 illustrates a network 100 of a plurality of computer networks. Each of the computer networks is associated with an organization. In the example illustrated in FIG. 1, the network 100 includes a first computer network 105 that is associated with a first organization, a second computer network 110 that is associated with a second organization, and a third computer network 115 that is associated with a third organization. Each computer network 105, 110, 115 in the network 100 includes a private database (for example, the private databases 120, 125, and 130) that includes a private threat repository (for example, the private threat repositories 135, 140, and 145). The private threat repository of each computer network is in communication with a shared threat repository 150 of a shared database 155 included in the network 100. In some embodiments, one or more of the computer networks 105, 110, 115 may include shared honeypot software 160, 165 or remote honeypot software 170 located on one or more computers (not illustrated), both of which will be described in further detail below. The computer networks included in the network 100 may be configured to communicate with each other as well as with the shared database 155 over one or more wired or wireless communication networks. In FIG. 1, a single instance of such a network is illustrated, namely network 175. Portions of the wireless communication network 175 may be implemented using a wide area network, for example, the Internet, a local area network, such as a Wi-Fi network, or a personal area network such as a Bluetooth™ network. Combinations or derivatives of these networks may also be used. It should be understood that the three computer networks included in FIG. 1 are purely for illustrative purposes and the network 100 may include a different number of computer networks. It should also be understood that the network 100 may include a different number of shared databases including shared threat repositories and the single shared database 155 included in FIG. 1 is purely for illustrative purposes. Also, in some embodiments the computer networks may communicate with one another or with the shared database 155 through one or more intermediary devices (not shown). For example, an intermediary computer may clean data that is sent from a private database to the shared database 155.

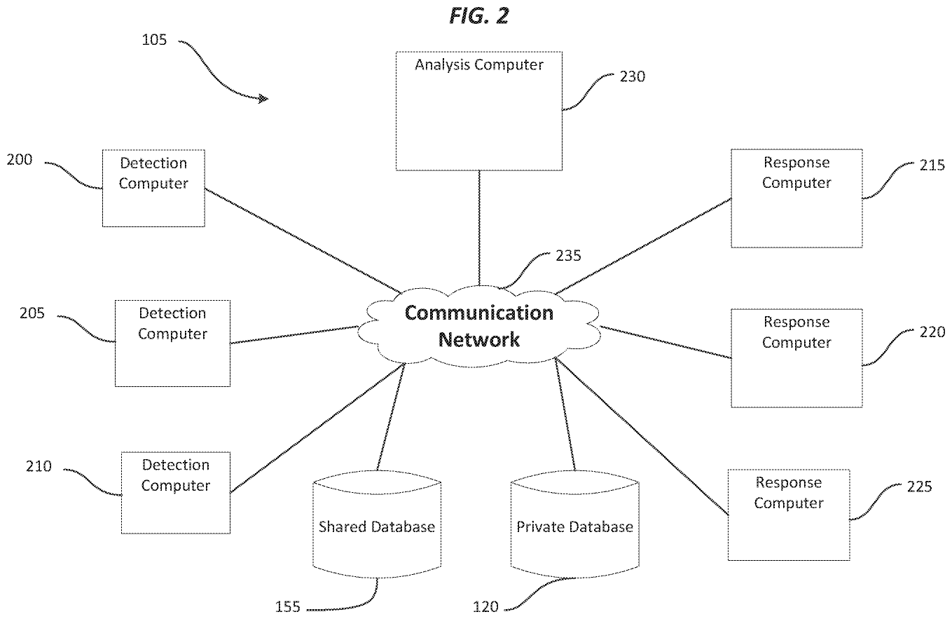

FIG. 2 illustrates an example of the first computer network 105 included in the network 100 of FIG. 1. The computer network 105 allows for the detection and reduction of cybersecurity threats. In the example shown, the computer network 105 includes a plurality of computers including detection computers 200, 205, 210, response computers 215, 220, 225, and an analysis computer 230. The computers included in the computer network 105 may be configured to communicate with each other as well as with one or more databases including, for example, the private database 120 and the shared database 155 over one or more wired or wireless communication networks 235. Portions of the wireless communication networks 235 may be implemented using a wide area network, for example, the Internet, a local area network, such as a Wi-Fi network, or a personal area network such as a Bluetooth™ network. Combinations or derivatives of these networks may also be used. It should be understood that the computer network 105 may include a different number of databases than the two databases shown in FIG. 2. Similarly, it should also be understood that the computer network 105 may include a different number of each of the detection computers, response computers, and analysis computer and the number of computers illustrated in FIG. 2 is purely for illustrative purposes. Also, in some embodiments the computers may communicate with one another or with the databases through one or more intermediary devices (not shown). It should also be understood that the computers illustrated in FIG. 2 may communicate with a plurality of user devices that are not illustrated in FIG. 2. Additionally, in some embodiments, the functionality described below as being performed by separate electronic processors on separate computers may be performed by a single electronic processor on a single computer.

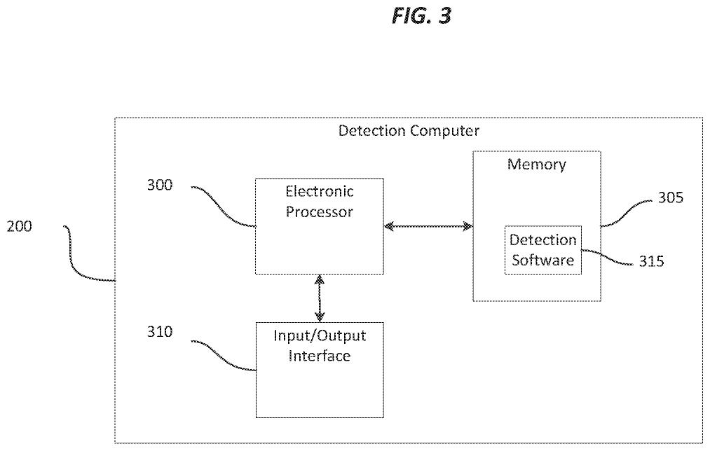

FIG. 3 illustrates an example of the detection computer 200. As illustrated in FIG. 3, the detection computer 200 is an electronic device that includes an electronic processor 300 (for example, a microprocessor, application-specific integrated circuit (ASIC), or another suitable electronic device), a memory 305 (a non-transitory, computer-readable storage medium), and a communication interface 310, such as a network interface or transceiver, for communicating over the communication network 235 and, optionally, one or more additional communication networks or connections. The electronic processor 300, the memory 305, and the communication interface 310 communicate, for example, over one or more communication lines or buses, or a combination thereof. It should be understood that the detection computer 200 may include additional components than those illustrated in FIG. 3 in various configurations and may perform additional functionality than the functionality described in the present application. Also, the functionality described herein as being performed by the detection computer 200 may be distributed among multiple devices, such as multiple computers operated within the computer network 105.

The detection computer 200 stores (for example, in the memory 305) detection software 315. The detection software 315 is a set of computer executable instructions that when executed by the electronic processor 300 monitor communication messages that are received by the detection computer 200 over the communication network 235. The detection software 315 may be, for example, intrusion detection system (IDS) software, system and authentication logs software, or honeypot software. The IDS software may be, for example, Bro IDS software which is an open source software created by Vern Paxton. The Bro IDS software monitors the identifiers of messages sent over a communication network (such as the communication network 235). Bro IDS software compares the identifiers of the messages sent over the communication network 235 to a plurality of known suspicious identifiers. Bro IDS software also has the ability to perform an analysis of a message to determine if the message is suspicious. The system and authentication log software creates system logs and authentication logs that may be used to determine if, for example, a user account attempting to access the first computer network 105 has been compromised. System logs include system events received from a user device that a system organizer has determined should be recorded. For example, system logs may include web server logs, error logs, mail logs, and host intrusion detection system logs. Authentication logs include 1) a record of attempts via user accounts to access a device or service provided by the first computer network 105 and 2) the IP address of the device that the attempt originated from. Honeypot software baits a cybersecurity threat with unimportant or false information in order to collect more data about the threat. It should be understood that, in some embodiments, the different types of detection software 315 installed on one or more detection computers 200, 205, 210 included in the computer network 105 work in parallel with each other.

In some embodiments, the detection software 315 may be remote honeypot software or shared honeypot software (for example, shared honeypot software 160). Remote honeypot software may be located on a detection computer in one computer network (for example, the third computer network 115) but be operated by another computer network (for example, the second computer network 110). Remote honeypot software located on a detection computer in one computer network and operated by another computer network allows multiple computer networks in the network 100 to respond to a cybersecurity threat detected by remote honeypot software in one computer network (preempting future cybersecurity attacks). Remote honeypot software also allows for the detection of simultaneous cybersecurity attacks and the comparison of the progress of cybersecurity threats across computer networks, and a comparison of response times (time between detecting a cybersecurity threat and performing an action in response to the cybersecurity threat) of each computer networks. In some embodiments, the network 100 includes shared honeypot software that forms a shared “honeyfarm” among participating organizations. Shared honeypot software shares information regarding detected cybersecurity threats directly and immediately with other computer networks in the network 100. Shared honeypot software is controlled by the computer network that it is located on. In some embodiments, containerization is employed by the network 100 as a way to deploy shared honeypot software. Containerization is an operating system feature in which the kernel allows the existence of multiple isolated user-space instances or containers. Programs running inside a container can only see the container's contents and devices assigned to the container. In some embodiments, containerization of the network 100 may be achieved by each computer network included in a honeyfarm executing containerization software, such as Docker created by Docker, Inc.

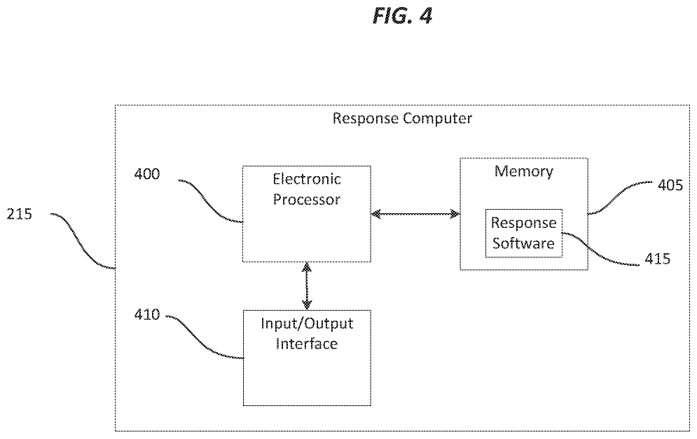

FIG. 4 illustrates an example of the response computer 215. In the example illustrated, the response computer 215 is an electronic device that includes an electronic processor 400 (for example, a microprocessor, application-specific integrated circuit (ASIC), or another suitable electronic device), a memory 405 (a non-transitory, computer-readable storage medium), and a communication interface 410, such as a network interface or transceiver, for communicating over the communication network 235 and, optionally, one or more additional communication networks or connections. The electronic processor 400, the memory 405, and the communication interface 410 communicate, for example, over one or more communication lines or buses, or a combination thereof. It should be understood that the response computer 215 may include additional components than those illustrated in FIG. 4 in various configurations and may perform additional functionality than the functionality described in the present application. Also, the functionality described herein as being performed by the response computer 215 may be distributed among multiple devices, such as multiple computers operated within the computer network 105.

The response computer 215 stores (in the memory 405) response software 415. Response software 415 is a set of computer executable instructions that when executed by the electronic processor 300 perform an action when a cybersecurity threat is detected by detection software on at least one of the detection computers in one of the computer networks included in the network 100. Response software 415 may block network traffic that is associated with a detected cybersecurity threat or may redirect network traffic associated with a detected cybersecurity threat in order to further analyze the detected cybersecurity threat. The response software 415 may be, for example, firewall software, intrusion protection system (IPS) software, black hole software, and software-defining network (SDN) software. It should be understood that while a firewall is described herein as being implemented in software in some embodiments the firewall may be implemented in hardware. If, for example, the response software 415 is IPS software, the response software 415 may include a plurality of rules that determine actions that the response software 415 performs in response to a specific cybersecurity threat. The rules included in the response software 415 are updated as new cybersecurity threats are detected by detection computers of computer networks included in the network 100. If, for example, the response software 415 is black hole software, the response software 415 may be located on a router and configured to redirect network traffic associated with a detected cybersecurity threat to a dead end computer. So, in this example, the determined action is to re-route network traffic associated with a threat. In some embodiments, the response software 415 may redirect network traffic associated with a detected cybersecurity threat in order to further analyze the detected cybersecurity threat by isolating the cybersecurity threat without making the cybersecurity threat aware that it has been detected. For example, in response to shared honeypot software identifying an IP address associated with a cybersecurity threat, a ruleset included in the SDN software on a response computer of one of the computer networks in the network 100 may be updated so that when the computer network receives a connection from the IP address associated with the cybersecurity threat, the connection is redirected to honeypot software. Honeypot software that the connection is diverted to may be isolated from the rest of the computer network but rich enough in information that the cybersecurity threat believes that it is successful, allowing information about the cybersecurity threat to be gathered by the honeypot software.

It should be understood that multiple types of response software may be distributed within the computer network 100. For example, the response computers 215, 220, 225 of the computer network 105 may each include a different type of response software. In one example, the response computer 215 includes IPS software, the response computer 220 includes SDN software, and the response computer 225 includes black hole software. Additionally, in some embodiments, a plurality of types of response software, rather than a single type of response software, may be configured to respond to a single detected cybersecurity threat. This is because different types of response software have different capabilities. For example, different types of response software have different delays in how quickly they respond to detected cybersecurity threats and different amounts of memory devoted to maintaining rule sets (determining how long they retain a response rule for a cybersecurity threat). For example, the IPS software included in the computer network 105 may refresh its rule set, for example, every 30 minutes, causing the IPS software to be delayed in responding to at least some detected threats. In another example, SDN software, firewall software, and black hole software respond to detected threats quickly, but devote a limited amount of memory to storing rule sets (compared to the IPS software). The different capabilities of different types of response software require computer networks to include a plurality of different types of response software in order to defend themselves against cybersecurity threats.

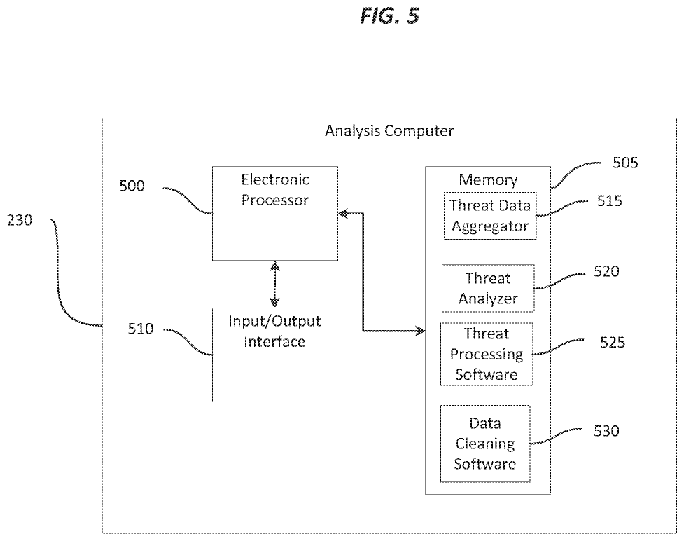

FIG. 5 illustrates an example of the analysis computer 230. In the example shown, the analysis computer 230 is an electronic device that includes a structure that is similar to that of other computers described herein. Thus, the details regarding the analysis computer 230 will not be explained other than to note that the analysis computer 230 shown includes an electronic processor 500, a memory 505, and a communication interface 510.

The analysis computer 230 stores (in the memory 505) a threat data aggregator 515, a threat analyzer 520, and threat processing software 525, and data cleaning software 530. The threat processing software 525 formats and normalizes the data received from the detection computers 200, 205, 210. The threat data aggregator 515, is executed by the electronic processor 500 and configured to combine (aggregate) cybersecurity threat data from a plurality of detection computers (a plurality of different types of detection software), cybersecurity threat data from a shared threat repository 150, and metadata from a plurality of devices included in the computer network 105. The threat analyzer 520 is executed by the electronic processor 500 and configured to use the aggregated data from the threat data aggregator 515 to determine patterns in the detected cybersecurity threat data and, in some embodiments, determine an action that should be performed by response software (such as the response software 415) on the response computers 215, 220, 225 when the threat is detected. For example, the threat analyzer 520 is configured to determine if there is suspicious activity recorded in the system and authentication logs. In some embodiments, threat analyzer 521) determines that there is a cybersecurity threat if there are a plurality of attempts to access the first computer network 105 by the same user account in a short time frame (for example, user X attempted to access the first computer network 105 fifty times in two minutes). In other embodiments, the threat analyzer 520 determines that there is a cybersecurity threat if the same user account attempts to access the first computer network 105 from two geographically disparate 1 addresses at approximately the same time.

In some embodiments, the threat analyzer 520 is also responsible for determining if the detected cybersecurity threat (cybersecurity threat data pertaining to the detected cybersecurity threat) should be added to the shared threat repository 150. When the threat analyzer 520 determines that a cybersecurity threat should be added to the shared threat repository 150 of the shared database 155, the threat analyzer 520 sends the cybersecurity threat to the data cleaning software 530. The data cleaning software 530 removes sensitive data and data that may be used to identify the organization from the data regarding the cybersecurity threat before sending the data to the shared threat repository 150.

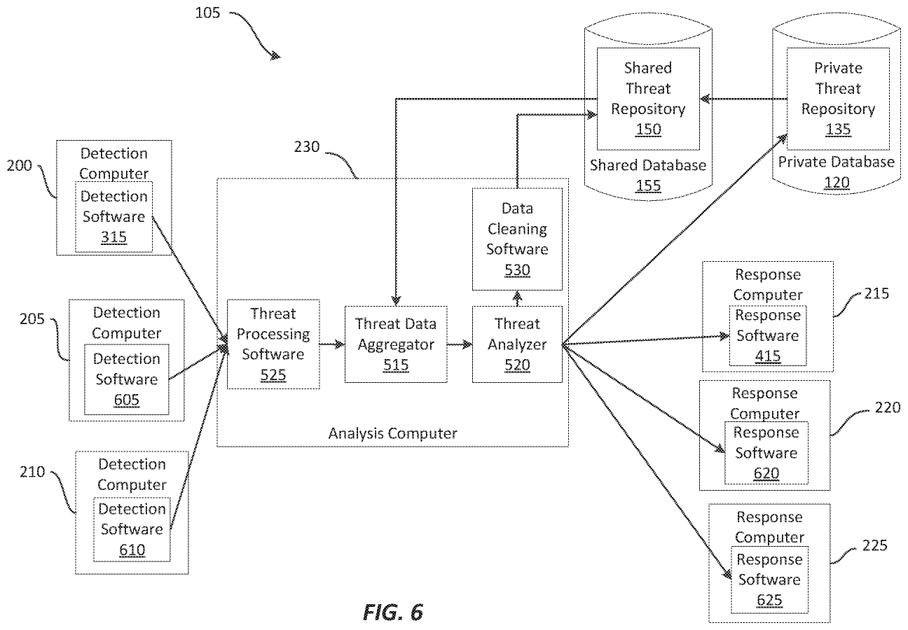

FIG. 6 illustrates one example of the flow of cybersecurity threat data between hardware components in the network 100 when a cybersecurity threat is detected in the first computer network 105 or cybersecurity threat data is received from the shared threat repository 150. Data about the detected cybersecurity threat is sent to the threat processing software 525 from the detection computer 200, the detection computer 205, and the detection computer 210, or a combination thereof. The detected cybersecurity threat data is then sent to the threat data aggregator 515. The threat data aggregator 515 may query the shared database 155 for cybersecurity threats recently added to the shared threat repository 150 by the second computer network 110 or the third computer network 115. The threat data aggregator 515 combines the detected cybersecurity threat data, the cybersecurity threat data from the shared database 155, and metadata from a plurality of devices included in the first computer network 105. The threat data aggregator 515 sends the combined cybersecurity threat data to the threat analyzer 520.

The threat analyzer 520 determines if there are patterns in the aggregated cybersecurity threat data. For example, the threat analyzer 520 determines if a cybersecurity threat is an isolated attack, an attack occurring across the first computer network 105, or is an attack that is occurring in a plurality of the computer networks in the network 100. The threat analyzer 520 also determines if a detected cybersecurity threat should be added to the private threat repository 135, the shared threat repository 150, both, or neither. As described above, in some embodiments, the threat analyzer 520 determines if data regarding the cybersecurity threat should be added to the shared threat repository 150 and if the threat analyzer 520 determines that the cybersecurity threat should be added to the shared threat repository 150, the threat analyzer 520 sends the cybersecurity threat data to the data cleaning software 530. In some embodiments, the private database 120 periodically sends updated cybersecurity threat information to the shared database 155. In these embodiments, the private database 120 may also include data cleaning software 530 to clean the cybersecurity threat data before sending it to the shared database 155 or may send the cybersecurity threat data to a computing device that includes data cleaning software 530.

In some embodiments, the threat analyzer 520 also determines an action that the response software 415, 620, 625 should perform in response to the cybersecurity threat. The threat analyzer 520 sends a signal to the response software 415, 620, 625 on the response computers 215, 220, 225 indicating the action that the response software 415, 620, 625 should perform in response to the cybersecurity threat. In some embodiments, once analyzed by the threat analyzer 520, the detected cybersecurity threat data and the cybersecurity threat data from the shared threat repository 150 is sent the plurality of response computers 215, 220, 225. The response software 415, 620, 625 in each of the response computers 215, 220, 225 performs the action in response to the cybersecurity threat.

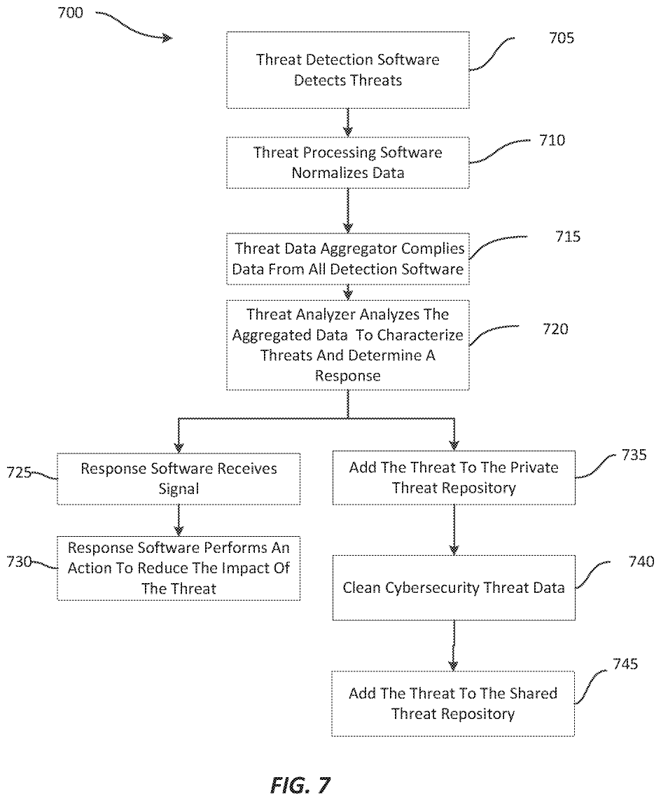

FIG. 7 illustrates an example method 700 for responding to detected cybersecurity threats. The method 700 begins when the detection software 315, 605, 610 detects a cybersecurity threat (block 705). In some embodiments, the method 700 begins when a cybersecurity threat is added to the shared threat repository 150 by the second computer network 110 or the third computer network 115 rather than when the detection software 315 detects a cybersecurity threat. The threat processing software 525 normalizes and formats the detected cybersecurity threat data before sending the cybersecurity threat data to the threat data aggregator 515 (block 710). The threat data aggregator 515 aggregates the cybersecurity threat data from the detection software 315, 605, 610 and the shared database 155 using the threat data aggregator 515 (block 715). The threat data aggregator 515 then sends the aggregated cybersecurity threat data to the threat analyzer 520. The threat analyzer 520 uses the aggregated cybersecurity threat data to characterize the cybersecurity threat and determine if there are patterns in the aggregated cybersecurity threat data (block 720). The threat analyzer 520 also determines the action the response software 415, 620, 625 should perform in response to the cybersecurity threat (block 720). The threat analyzer 520 sends a signal to the response software 415, 620, 625 on the response computers 215, 220, 225 indicating the action that the response software 415, 620, 625 should perform in response to the cybersecurity threat. When the response software 415, 620, 625 receives the signal regarding the cybersecurity threat (block 725), the response software 415, 620, 625 performs an action that limits the effects of the cybersecurity threat on the first computer network 105 and in some embodiments prevents the cybersecurity threat from affecting the first computer network 105 (block 730).

The threat analyzer 520 also, concurrent to sending the signal to the response computers 215, 220, 225 (block 725), sends the cybersecurity threat data to the private database 120 for inclusion in the private threat repository 135. Data about the cybersecurity threat is then added to the private threat repository 135 (block 735). In some embodiments, the threat analyzer 520 also determines if the detected cybersecurity threat should be added to the shared threat repository 150. If, for example, the cybersecurity threat data that the threat analyzer 520 is analyzing was received from the shared threat repository 150, the cybersecurity threat data should not be added to the shared threat repository 150. If the threat analyzer 520 determines that the cybersecurity threat data should be added to the shared threat repository 150, the analysis computer 230 sends the cybersecurity threat data to the shared database 155 to be added to the shared threat repository 150. In other embodiments, the private database 120 sends the cybersecurity threat data to the shared database 155 for inclusion in the shared threat repository 150. Regardless of whether the threat analyzer 520 or the private database 120 sends the cybersecurity threat data to the shared database 155, in the example provided, the cybersecurity threat data is cleaned (block 740) before it is sent to the shared database 155 for inclusion in the shared threat repository 150 (block 745).

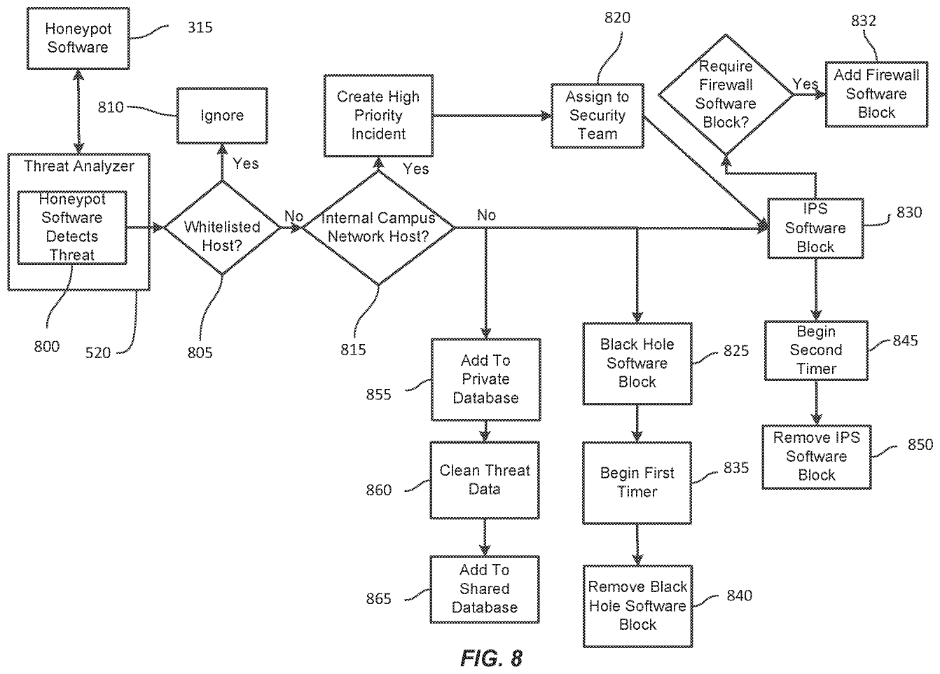

FIG. 8 illustrates the functionality that the first computer network 105 performs, in one example, when honeypot software (the detection software 315) detects a cybersecurity threat in the first computer network 105. In the case that the detection software 315 is honeypot software, the threat analyzer 520 analyzes the cybersecurity threat and determines a response to the detected cybersecurity threat and sends data regarding the cybersecurity threat to the response software 415, 620, 625 included in the response computers 215, 220, 225. For example, if a host that is the origin of the cybersecurity threat detected by the honeypot software is a whitelisted host (a trusted host) (block 805), the cybersecurity threat is determined to be safe and is ignored (block 810). If the host is not whitelisted and is associated with the first computer network 105 (block 815), the response software 415 sends the cybersecurity threat data to a user notification device (for example, a user management system computer or, in some cases, a laptop or other portable device) manned by cybersecurity threat analysis personnel so that the personnel may perform an in-depth analysis of the cybersecurity threat (block 820). If the host is not associated with the first computer network 105, data regarding the cybersecurity threat is sent to black hole software (block 825) and IPS software (block 830). In some embodiments, it is determined that a cybersecurity threat also requires that a firewall software block be implemented in addition to the black hole software block and the IPS software block (block 832). The black hole software provides a faster response to a detected cybersecurity threat in comparison to the IPS software. When the black hole software receives data regarding a cybersecurity threat (block 825), a first timer begins (block 835) which determines how long the black hole software will implement the response to the cybersecurity threat (when the first timer ends, the black hole software block is removed) (block 840). A second timer begins when the IPS software receives a notification of a cybersecurity threat (block 845). The second timer determines how long the IPS software wall implement a response to the cybersecurity threat (when the first timer ends, the IPS software block is removed) (block 850). In some embodiments, the first timer expires before the second timer. For example, the first timer expires after one hour while the second timer expires after seven days.

Concurrent to sending the cybersecurity threat to the response computers 215, 220, 225, the threat analyzer 520 sends the cybersecurity threat to the private database 120 for storage in the private threat repository 135 (block 855). Additionally, the private database 120 or the threat analyzer 520 may clean the cybersecurity threat data (block 860) and send the cybersecurity threat data to the shared database 155 for storage in the shared threat repository 150 (block 865).

It should be understood that the threat analyzer 520 may be able to query the honeypot software (the detection software 315) as it analyzes a threat. Additionally, it should be understood that the threat analyzer 520 may send information about a detected threat to the honeypot software to improve the honeypot's ability to detect threats. It should also be understood that there may be further steps associated with analyzing, storing, and responding to a cybersecurity threat than are illustrated in FIG. 8 but these steps have not been included in FIG. 8 for the sake of simplicity and clarity.

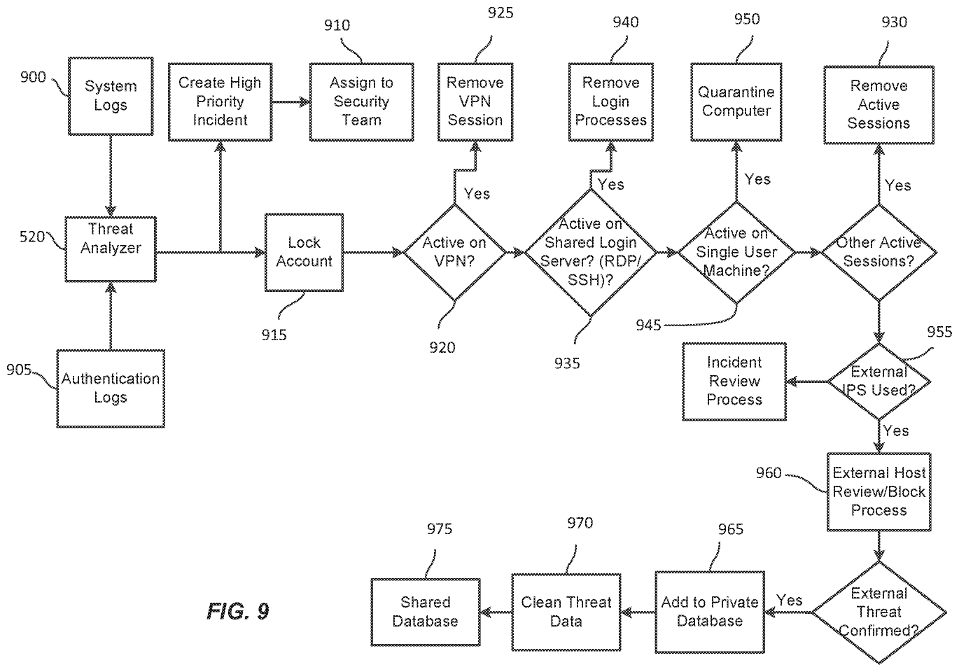

FIG. 9 illustrates one example of the functionality that the first computer network 105 is configured to perform when the threat analyzer 520, detects a cybersecurity threat in the first computer network 105 by analyzing system logs 900 and authentication logs 905. When the threat analyzer 520 determines that a there is a cybersecurity threat in the first computer network 105, the response software 415 sends a message to a user notification device to notify cybersecurity threat analysis personnel (block 910) and locks the user account associated with the cybersecurity threat (block 915). In some embodiments, if the user account has an active virtual private network session (block 920) and, if the user account is active on the virtual private network, the response software 415 removes the virtual private network session associated with the user account (block 925). The response software 415 may also remove any other active sessions associated with the user account (block 930). Additionally, in some embodiments, if the user account has an active login process on a shared login server (for example, an secure shell (SSH) server or a remote desktop protocol (RDP) server) (block 935), the response software 415 removes the active login process associated with the user account from the shared login server (block 940). If the user account is active on an individual user device (block 945), the response software 415 may quarantine the user device the user account is active on (block 950).

If the user account attempted to access the first computer network 105 from an IP address that is external to the first computer network 105 (the cybersecurity threat originated at a host that is external to the first computer network 105) (block 955), the response software 415 blocks the external host from the first computer network 105 (block 960). In some embodiments, the threat analyzer 520 also sends the cybersecurity threat to the private database 120 for storage in the private threat repository 135 (block 965). Additionally, the private database 120 or the threat analyzer 520 may clean the cybersecurity threat data (block 970) and send the cybersecurity threat data to the shared database 155 for storage in the shared threat repository 150 (block 975).

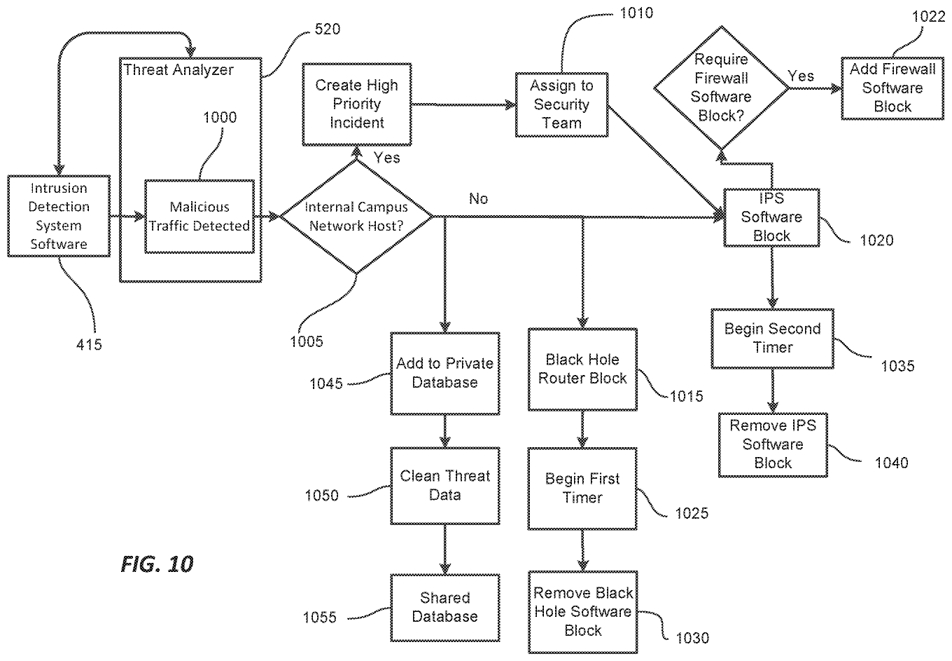

FIG. 10 illustrates one example of the functionality that the first computer network 105 is configured to perform when IDS software (the detection software 315) detects a cybersecurity threat in the first computer network 105. The threat analyzer 520 analyzes the cybersecurity threat and determines a response to the detected cybersecurity threat and sends data regarding the cybersecurity threat to the response software 415, 620, 625 included in the response computers 215, 220, 225 (block 1000). For example, if a host that is the origin of the cybersecurity threat detected by the IDS software originated from a host that is associated with the first computer network 105 (block 1005), the threat processing software 525 sends the cybersecurity threat to a user notification device manned by cybersecurity threat analysis personnel so that they may perform an in-depth analysis of the cybersecurity threat (block 1010). If the host is not associated with the first computer network 105, data regarding the cybersecurity threat is sent to a black hole software (block 1015) and IPS software (block 1020). In some embodiments, it is determined that a cybersecurity threat also requires that a firewall software block be implemented in addition to the black hole software block and the IPS software block (block 1022). The black hole software provides a quick response to a detected cybersecurity threat while the IPS software takes longer to respond to the cybersecurity threat. When the black hole software receives data regarding a cybersecurity threat, a first timer begins (block 1025) which determines how long the black hole software will implement the response to the cybersecurity threat (when the first timer ends, the black hole router block is removed) (block 1030). A second timer begins when the IPS software receives a notification of a cybersecurity threat (block 1035). The second timer determines how long the IPS software will implement a response to the cybersecurity threat (when the second timer ends the IPS software block is removed) (block 1040). In some embodiments, the first timer expires before the second timer. For example, the first timer expires after one hour while the second timer expires after seven days.

In one example, concurrent to sending the cybersecurity threat to the response computers 215, 220, 225, the threat analyzer 520 sends the cybersecurity threat to the private database 120 for storage in the private threat repository 135 (block 1045). Additionally, the private database 120 or the threat analyzer 520 may clean the cybersecurity threat data (block 1050) and send the cybersecurity threat data to the shared database 155 for storage in the shared threat repository 150 (block 1055).

It should be understood that the threat analyzer 520 may be able to query the IDS software (the detection software 315) as it analyzes a threat. Additionally, it should be understood that the threat analyzer 520 may send information about a detected threat to the IDS software to improve the IDS software's ability to detect threats. It should also be understood that there may be further steps associated with analyzing, storing, and responding to a cybersecurity threat than are illustrated in FIG. 10 but these steps have not been included in FIG. 10 for the sake of simplicity and clarity.

Thus, embodiments provide, among other things, a network for the detection and reduction of cybersecurity threats. Various features and advantages of some embodiments are set forth in the following claims.

What is claimed is:

1. A threat analyzer that is configured to
receive cybersecurity threat data;
perform an analysis of the cybersecurity threat data;
determine an action to be performed by response software on response computers in response to a cybersecurity threat; and
add the cybersecurity threat data to a private threat repository on a private database.

2. The threat analyzer according to claim 1, wherein the threat analyzer is configured to determine whether the cybersecurity threat data should be added to a shared threat repository.

3. The threat analyzer according to claim 1, wherein the threat analyzer is configured to perform an analysis of the cybersecurity threat data by using cybersecurity threat data from a plurality of detection computers, a shared threat repository, or both.

4. The threat analyzer according to claim 3, wherein the threat analyzer is configured to receive cybersecurity threat data from detection software executing on the plurality of detection computers, the shared threat repository, or both is combined by a threat data aggregator.

5. The threat analyzer according to claim 1, wherein the threat analyzer is configured to send information regarding the cybersecurity threat to detection software to improve an ability of the detection software to detect threats.

6. The threat analyzer according to claim 1, wherein the action is at least one selected from the group consisting of blocking the cybersecurity threat using black hole software, firewall software, intrusion protection system software, software-defining network software, or a combination of the foregoing, redirecting the cybersecurity threat to a user notification device, and redirecting the cybersecurity threat to detection software.

7. The threat analyzer according to claim 4, wherein the detection software includes honeypot software, intrusion detection system software, system and authentication logs software, or a combination of the foregoing.

8. The threat analyzer according to claim 2, wherein the threat analyzer is configured to:
clean the cybersecurity threat data of sensitive data or data that may be used to identify an organization that the data originated from; and
send the cleaned cybersecurity threat data to a shared database including the shared threat repository.

9. The threat analyzer according to claim 1, wherein the threat analyzer is configured to perform an analysis of the cybersecurity threat data by querying detection software for additional information regarding the cybersecurity threat data.

10. A computer network for the detection and reduction of cybersecurity threats, the computer network comprising:
a plurality of detection computers, each configured to, when executing detection software with an electronic processor, detect a cybersecurity threat;
a plurality of response computers, each configured to, when executing response software with an electronic processor, perform an action in response to the detected cybersecurity threat on the computer network;
a threat data aggregator configured to, when executed by the electronic processor, communicate with the plurality of detection computers and the plurality of response computers and to receive data regarding the detected cybersecurity threat; and
a threat analyzer configured to, when executed by the electronic processor, determine a response to the detected cybersecurity threat.

11. The computer network according to claim 10, further comprising a private database including a private threat repository and wherein the threat analyzer is further configured to, when executed by the electronic processor, send the detected cybersecurity threat to the private database including the private threat repository.

12. The computer network according to claim 10, further comprising a shared database that includes a shared threat repository and is configured to communicate with a plurality of computer networks.

13. The computer network according to claim 11, wherein the threat analyzer is configured to use data from a shared threat repository to determine the response to the detected cybersecurity threat.

14. The computer network according to claim 12, wherein data in the shared threat repository is cleaned of sensitive data or data that may be used to identify an organization that the data originated from.

15. The computer network according to claim 10, wherein the action is at least one selected from the group consisting of blocking the cybersecurity threat using black hole software, firewall software, intrusion protection system software, software-defining network software, or a combination of the foregoing, redirecting the cybersecurity threat to a user device, and redirecting the cybersecurity threat to the detection software.

16. The computer network according to claim 10, wherein the detection software includes honeypot software, intrusion detection system software, system and authentication logs software, or a combination of the foregoing.

17. The computer network according to claim 10, wherein the threat analyzer is configured to determine whether to add the detected cybersecurity threat to a shared threat repository.
